(19) United States
(12) Patent Application Publication
(10) Pub. No.: US 2006/0044552 A1
(43) Pub. Date: Mar. 2, 2006

(54) A device for measuring motion along surfaces of arbitrary length and of arbitrary curvature.

(75) Inventors: Mark Randall Hardin, North Hollywood, CA (US); Mark Alan Hotchkiss, Long Beach, CA (US)

Correspondence Address: MOTOR REFLEX, INC., P. O. BOX 7153, BURBANK, CA, 91510-7153, US

(73) Assignees: Mark Randall Hardin, N. Hollywood, CA (US); Mark Alan Hotchkiss, Long Beach, CA (US)

(21) Appl. No.: 10/711,231

(22) Filed: Sep. 2, 2004

(51) Int. Cl. G01N 21/88

(52) U.S. Cl. 356/237.2

(57) ABSTRACT

A measuring device comprising a sensor capable, through slideable displacement, of detecting alternating reflective and non-reflective markings on surfaces which can be planar or curved, and can be of any length. The output of said sensor can be utilized by other devices, to determine distance, velocity, acceleration or other factors.

### BACKGROUND

Motion picture visual effects often require the photography of multiple individual images, which must be combined to form one integrated image. If that composite image is intended to appear as from a spatially moving viewpoint, then all the aforementioned individual images may also be required to be imaged from that identical moving viewpoint. The process of repeatably imaging a physically moving viewpoint forms the basis for what is commonly known as “motion-control” photography, in which motorized devices move the viewpoint in predetermined or recordable trajectories or spatial pathways. In some cases, a viewpoint's spatial path may need to be recorded for other purposes, such as acquiring the data necessary for computer generated imagery, a process commonly referred to as “motion capture”.

Many types of devices have been designed to carry cameras with varying degrees of spatial freedom. Most of these devices, from simple pan-and-tilt camera heads to more complex camera cranes, are comprised of mechanically linked elements, each element moving relative to the next. The motion of each of these elements relative to its adjacent element may need to be measured in order to determine the resultant spatial position of a camera held at the end of such a series of linked elements.

One of the more difficult of these axes of motion to accurately measure has traditionally been the movement between a camera cart, or “dolly”, and the track it rides upon. Factors contributing to this difficulty include the fact that track is built from individual sections which must be joined, the variable and potentially long distances over which the dolly may travel, and that some sections of track may need to be curved.

Several types of approach have been taken in the past to attempt accurate measurement between dolly and track. The approach most frequently taken consists of measuring the motion of a motor driving the dolly. Whether the drive mechanism to which the motor is attached is based on mechanical principles such as rack-and-pinion gearing, timing belt, friction drive or other such means, these drives may ensure repeatable measurements at the drive itself but, due to issues of backlash, compliance, or slippage, measurements taken at the motor in such mechanisms may not necessarily provide an accurate representation of movement between the dolly and the track.

In cases where a drive was unnecessary or undesirable, various devices have been used for measurement between dolly and track. A simple friction-contact rubber-wheeled capstan on a common shaft with an encoder, mounted to the dolly and rolling in contact with the track has commonly been used but, due to slippage between capstan and rail, requires frequent recalibration to some reference point on the track. Another approach has been to attach one end of a cable to the dolly, with the cable's opposite end wound on the shaft of a rotary encoder attached to one end of the track, while maintaining constant tension on the cable. Dolly movement in this configuration results in a corresponding encoder shaft rotation, allowing a resultant encoder signal to be generated. Measurement inaccuracy in such applications can result due to elasticity in the cable, and applications requiring the use of curved track sections have prohibited use of this approach.

In film and video production, minimizing setup time is considered to be of great importance. These aforementioned track drive measurement implementations share common drawbacks in such an environment: they may require considerable time to assemble mechanical and electronic components, to align these components, and to calibrate the system to known reference points and in meaningful units of measurement.

The goal of this new approach is a system that, among other advantages, is quick and easy to set up and calibrate, maintains its accuracy in situations where there may be backlash in the drive, can operate with combinations of straight and curved track, works with our without an external drive, and is compatible with most existing track and drive systems.

This new approach places a sensor on the dolly and markings along some surface of the track. The markings are either pre-applied to the track, or applied to the track after the track sections have been assembled. The sensor detects and decodes the markings to produce information about the dolly's motion in real-time, whether that information is position, velocity or acceleration. The information may be used simply to record the motion, or even used to close a servo loop. This approach works well whether a person pushes the dolly or a motor drives the dolly.

One may argue that the advantages of this new approach may be realized by using ordinary linear encoders. But linear encoders fail in aforementioned application because of the following deficiencies:

A. Only short lengths are practical. Linear encoders are expensive, especially in long lengths, and linear encoders are not available in sections that can be joined. They are certainly not available in the arbitrary lengths required for film and video production.

B. Though straight encoder scales are readily available, curved scales are not. The curved scales that do exist are short, and only curve in one direction. They also are very expensive.

C. Linear encoder scales are difficult to align with their sensor, and often require special enclosures to maintain alignment. Alignment can also be time-consuming.

### BRIEF DESCIPTION OF THE DRAWINGS

FIG. 1 is a generalized perspective view of a surface (of arbitrary length and curvature) and a sensor moving along this surface.

FIG. 2 shows the sensor in centered-cross-section top view, and the surface it is reading shown in slight perspective. Essential elements of the sensor are shown in diagrammatical form.

FIG. 3 is a top view of a housing for the sensor, shown in contact with a curved surface.

FIG. 4 is a side view of the housing in FIG. 3.

FIG. 5 is a top view of a housing for the sensor, shown with a pair of attached wheels rolling in contact with the curved surface.

FIG. 6 is a side view of the housing in FIG. 5.

FIG. 7 is a perspective view of the preferred embodiment in a typical application.

### DETAILED DESCRIPTION OF THE INVENTION

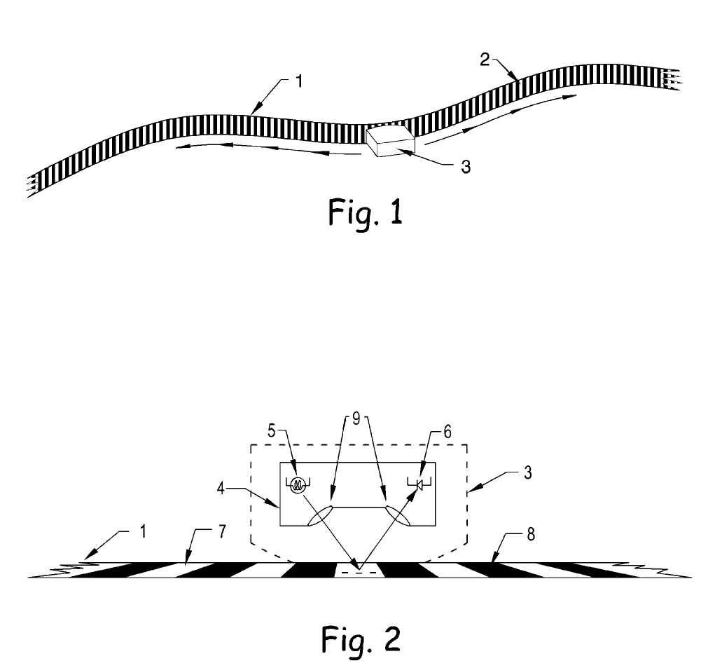

A typical embodiment shown in FIG. 1 consists of a surface of arbitrary length and curvature 1, on which are alternating reflective and non-reflective markings 2 and a sensor 3 capable of reading said markings. Displacement is read by interpreting the sensor's 3 output as it is moved along the surface 1.

FIG. 2 shows the optics 4 of the sensor 3, consisting of a light source 5 and one or more light detectors 6. Light from the light source is directed toward the surface 1. If a detector is primarily aligned with one or more reflective area(s) 7 on surface 1, the detector 6 senses reflected light above a predetermined threshold level. Conversely, if a detector is primarily aligned with one or more non-reflective area(s) 8 on surface 1, the light reflected to the detector 6 falls below said threshold level. The output of the light detector will be either on or off, depending on whether the reflected light level is detected as above or below said threshold. As the detector travels from alignment with reflective area(s) to alignment with non-reflective area(s), the reflected light drops below said threshold, and the sensor's output changes states. As the detector travels further to alignment with the next reflective area(s), the sensor's output state changes back again. These state changes may be interpreted by external devices to obtain various measurements.

When two detectors 6 are used, they may be positioned such that their outputs are phased in the same way as a standard industrial quadrature encoder.

Lenses 9 may or may not be used at the light source 5 and/or the detectors 6 to better focus the light.

A specific distance between the optics 4 and the surface 1 may be required for proper detector performance.

In the currently preferred embodiment, the measured surface consists of a tape with one reflective side and an adhesive coating applied to its opposite side. A multitude of individual non-reflective markings are continuously printed on the tape's reflective side by a seamless-plate flexographic process. By its nature, the adhesive tape can be applied to a surface of any desired length or curvature.

In the preferred embodiment, the emitter 5 and detector 6 are both contained within a commercially available surface-mount electronic encoder chip package, the Agilent HEDR-8000, which includes a single LED light emitter, a pair of lenses, and a photodetector IC. The chip package is connected to a differential line driver on a printed circuit board with additional components, which allow it to behave as a standard industrial quadrature encoder.

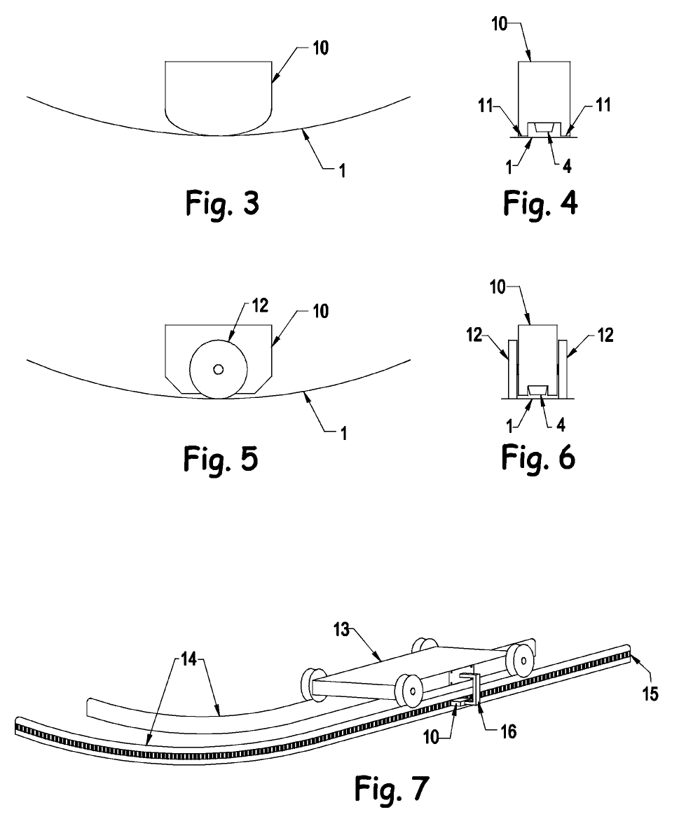

Optical characteristics of the emitter and detector may require a specific range of separation between the optics 4 and the surface 1 that the sensor is to read. FIG. 3 and FIG. 4 show a sensor housing for the currently preferred embodiment. The optics 4 are mounted in a housing 10, which holds the optics rigidly. FIG. 4 shows the parallel runners 11 on both sides of the optics, establishing said separation between optics 4 and surface 1 when housing 10 is held in contact with the surface. Depending on the width of the tape and the configuration of the sensor, these runners can be arranged to ride on the surface to which the tape is adhered, or on the surface of the tape itself. The faces of these runners 11, which are in contact with said surface 1, are shaped to permit travel along surfaces of concave radii.

FIG. 5 and FIG. 6 show a sensor housing which replaces the runners seen in FIG. 3 and FIG. 4 with one, two or more wheels 12. As in FIGS. 3 and 4, the wheels establish the proper separation between optics 4 and surface 1 when housing 10 is held in contact with the surface.

FIG. 7 shows the preferred embodiment in a typical application. A four-wheeled cart or dolly 13 rides constrained on parallel pairs of rails 14, which can be any combination of straight rail or rail curved in a leftward or rightward direction. The tape 15 containing the alternating reflective and non-reflective markings is adhered to a vertical side surface of one or both rails 14. In FIG. 7, the tape is shown applied to an outer rail surface. The sensor's housing 10 is held in contact with the surface, or with the tape applied to that surface, by an arm system 16 rigidly attached at its opposite end to the cart 13. The arm system 16 contains a mechanism that applies the required pressure to maintain contact between sensor housing 10 and the surface or tape. In order to maintain the proper contact, the arm's design permits motion between the sensor and the cart in a direction perpendicular to the length of the rails, but motion parallel to the rails is minimized to ensure that measurements at the sensor represent motion of the cart along the rails as closely as possible.

What is claimed is:

1. A measuring device comprising:
(a) a surface of arbitrary length and curvature upon which is placed a multitude of alternating reflective and non-reflective markings, and
(b) a sensor capable of detecting said alternating reflective and non-reflective markings whereby displacement between said sensor and said surface is measured through slideable movement between said sensor and said surface of arbitrary length and curvature.

2. A measuring device as defined in claim 1 wherein said alternating reflective and non-reflective markings are contained on an adhesive tape, which is subsequently applied to said surface.

3. A measuring device as defined in claim 1 wherein said surface is inherently non-reflective and said reflective markings are applied to said non-reflective surface.

4. A measuring device as defined in claim 1 wherein said surface is inherently reflective and said non-reflective markings are applied to said reflective surface.

5. A measuring device as defined in claim 1 wherein said surface is inherently reflective, a non-reflective coating is applied to said reflective surface, and alternating reflective areas are subsequently revealed by selective removal of said non-reflective coating.

6. A measuring device as defined in claim 1 wherein said surface is inherently non-reflective, a reflective coating is applied to said non-reflective surface, and alternating non-reflective areas are subsequently revealed by selective removal of said reflective coating.

7. A measuring device as defined in claim 1 wherein 2 sets of said sensors and their corresponding alternating reflective and non-reflective markings are oriented at 90 degrees to one another on a single surface, permitting measurement in two perpendicular dimensions.

8. A measuring device as defined in claim 1 wherein the output of said sensor consists of one electronic signal, thereby able to measure motion in one direction only.

9. A measuring device as defined in claim 1 wherein the output of said sensor consists of two electronic signals, oriented 90 electrical degrees from each other, thereby able to measure motion in both directions.

10. A measuring device as defined in claim 1 wherein the output of said sensor includes an electronic signal that indicates the presence of a reference mark.

11. A measuring device as defined in claim 1 wherein the electronic signals of said sensor's output are analog representations of the amount of light detected by the sensor.

12. A measuring device as defined in claim 1 wherein the electronic signals of said sensor's output are made to conform to RS-422 differential signaling standards.

13. A measuring device as defined in claim 1 wherein the electronic signals of said sensor's output are made to be compatible with TTL inputs.

14. A measuring device as defined in claim 1 wherein a multiple of said detectors are used in order to detect and recover from any flaws that may exist in said surface.
